(19) United States
(12) Patent Application Publication
(10) Pub. No.: US 2023/0221708 A1
(43) Pub. Date: Jul. 13, 2023

(54) SYSTEM AND METHOD OF ENHANCING RELIABILITY OF FUSED DEPOSITION MODELLING (FDM) PROCESS USING A NOZZLE CAMERA AND ARTIFICIAL INTELLIGENCE

(71) Applicant: Mech Solutions Ltd, Concord (CA)

(72) Inventors: Xingchen Liu, Toronto (CA); Beenish Sharif, Vaughan (CA); Haoliang Zhou, Vaughan (CN); Jiachun Wang, Toronto (CA); Ziqi Chen, Toronto (CA); Xunchao Zhang, Waterloo (CA)

(21) Appl. No.: 17/573,174

(22) Filed: Jan. 11, 2022

(51) Int. Cl. G05B 19/418; G06T 7/00; H04N 5/225; G05B 19/4099; B33Y 50/00; B29C 64/386

(52) U.S. Cl. CPC G05B 19/41875; G06T 7/0004; H04N 5/2251; G05B 19/4099; B33Y 50/00; B29C 64/386; G06T 2207/30144; G05B 2219/49023; G05B 2219/32368

(57) ABSTRACT

A system and a method of enhancing reliability of fused deposition modelling (FDM) process are disclosed. The system instructs a three-dimensional (3D) printer to employ a 3D printer nozzle for dispensing material for forming a 3D print object. The system receives images from a nozzle camera. The nozzle camera captures images of the 3D printer nozzle dispensing the material. The system detects printing failures from the images of the 3D printer nozzle. The system creates bounding boxes around the printing failures. The system classifies the printing failures based on type of errors. The system adjusts printing parameters or terminates the printing process based on the printing failures classified. The system further includes a bracket for positioning the nozzle camera for capturing images of the 3D printer nozzle.

### FIELD OF THE DISCLOSURE

The present invention generally relates to three-dimensional (3D) printers. More specifically, the present invention relates to a system and method of enhancing reliability of fused deposition modelling (FDM) process using a nozzle camera and artificial intelligence.

### BACKGROUND OF THE DISCLOSURE

It is known that printing failures are prevalent in a fused deposition modelling (FDM) process. Existing technologies cannot identify the failures immediately or even quickly, which harms the reliability of three-dimensional (3D) printing processes. It usually takes a long period of time say longer than one minute, to detect failures in printing. This is because failure detection models wait for small errors to grow large and become recognizable failures in order to make accurate detection decisions. As a result, a lot of resources, such as material (filaments) and time, is wasted. As a result, the overall production efficiency of the 3D printing process is hindered.

In order to overcome the above problems, several attempts have been made in the past to develop detection systems to improve the performance of FDM processes using camera-based monitoring and statistical or Artificial intelligence (AI) algorithms. One such solution is a system that detects 3D printing failures by characterizing the state of the FDM printer with its vibrational signal. The system calculates the correlation of the collected signal to different machine states. Another solution is an optical in-situ verification system that records images of the print layer and compares the layer with the original G-code to detect failures. Here, the optical in-situ verification system includes a camera that records the image of the entire print layer of the printed object.

Further, commercial services like the Spaghetti Detective are a 3D printing error detection platform that uses AI-based algorithms to detect printing failures with a normal webcam that monitors the printed object. Here, the system uses a deep learning algorithm to recognize defections, and recognizes only one type of printing failure, i.e., spaghetti. Further, the system includes a nozzle motor that blocks the view of the camera, making it harder to identify the failure immediately. The system lacks lighting in the surrounding and that impacts the accuracy of the failure detection.

An improvement of the above solution includes monitoring the nozzle deviation of the FDM printer. The system uses a faster Region-based Convolutional Neural Network (RCNN) and a white balance algorithm as the detector for detecting nozzle deviation of the 3D printer. Here, the system records the images from four different cameras pointing at the nozzle and processes the images to detect 3D printing failures.

Another solution is disclosed in a United States Patent Publication No. 20200160497, entitled “Machine based three-dimensional (3D) object defect detection” (“'497 Publication”). The '497 Publication discloses systems and methods for machine-based defect detection of three-dimensional (3D) printed objects. A method of one embodiment of the disclosure includes providing a first illumination of a 3D printed object using a first light source arrangement. A plurality of images of the 3D printed object are then generated using one or more imaging devices. Each image may depict a distinct region of the 3D printed object. The plurality of images may then be processed by a processing device using a machine learning model trained to identify one or more types of manufacturing defects of a 3D printing process. The machine learning model may provide a probability that an image contains a manufacturing defect. The processing device may then determine, without user input, whether the 3D printed object contains one or more manufacturing defects based on the results provided by the machine learning model.

Yet another solution is disclosed in a United States Patent Publication No. 20200307101, entitled “Systems and methods for defect detection in three-dimensional printed constructs” (“101 Publication”). The '101 Publication discloses a system for detecting defects in a printed construct includes one or more processors, one or more image sensors, and one or more memory modules. The one or more image sensors are communicatively coupled to the one or more processors. Machine readable instructions are stored on the one or more memory modules that, when executed by the one or more processors, cause the system to collect image data of a three-dimensional printed construct from the one or more image sensors, and detect one or more defects within the image data of the three-dimensional printed construct.

Yet another solution is disclosed in a United States granted U.S. Pat. No. 11,084,225, entitled “Systems, methods, and media for artificial intelligence process control in additive manufacturing” (“the '225 patent”). The '225 patent discloses systems, methods, and media for additive manufacturing. In some embodiments, an additive manufacturing system comprises: a hardware processor that is configured to: receive a captured image; apply a trained failure classifier to a low-resolution version of the captured image; determine that a non-recoverable failure is not present in the printed layer of the object; generate a cropped version of the low-resolution version of the captured image; apply a trained binary error classifier to the cropped version of the low-resolution version of the captured image; determine that an error is present in the printed layer of the object; apply a trained extrusion classifier to the captured image, wherein the trained extrusion classifier generates an extrusion quality score; and adjust a value of a parameter of the print head based on the extrusion quality score to print a subsequent layer of the printed object.

Although the above discussed solutions can detect 3D printing failures, they are not capable of detecting printing failures at the very beginning and as a result reduces the reliability of entry-level FDM based printers. This is because; the existing systems have slow response time to detect failures. Normally, the nozzle head of 3D printers, where material is extruded, blocks the view of cameras. Conventional AI systems must wait until the error becomes convincingly visible, which means that the nozzle motor head cannot block the print object, and the failure must be large enough for it to be recognized. These difficulties cause a long response time of current detection technologies.

In addition, the existing systems have low accuracy. This is because; the existing systems require full images of the printed object, as a result, existing failures will only occupy small parts of collected images. Such a small part of images cannot provide enough feature information for AI models to make accurate predictions. Given fewer details of printing failures, it is likely for AI models to make inaccurate predictions.

Generally, the status of nozzle, or the condition of filament extrusion, is much important. Different incorrect nozzle conditions (too low/high nozzle temperature, incorrect flow rate, incorrect retraction setting) will lead to the spaghetti, over/under extrusion and stringing. The combination of longer response time and lower accuracy reduces the reliability of 3D printing and the usage of AI systems.

Therefore, there is a need for a system with faster detection time and higher prediction accuracy for current 3D printing technologies, the system comprising a camera targeting directly at the nozzle and capable of detecting the failures or errors immediately and altering the printing parameters setting to fix the printing process very quickly.

### BRIEF SUMMARY OF THE DISCLOSURE

It is an object of the present invention to provide a system for enhancing reliability of fused deposition modelling (FDM) process that avoids the drawback of known methods.

It is another object of the present invention to provide an object detection-based reliability enhancement system for 3D printing processes using a nozzle camera.

It is another object of the present invention to provide a system that uses a nozzle camera pointing at the nozzle of the 3D printer, and use cutting edge object detection algorithms to predict printing failures.

It is another object of the present invention to provide a system that detects and corrects FDM processes through detecting various types of printing errors at the nozzle of the FDM printer.

In order to overcome the problems in the prior art, the present invention provides a system and a method of enhancing reliability of fused deposition modelling (FDM) process. The system instructs a three-dimensional (3D) printer to employ a 3D printer nozzle for dispensing material for forming a 3D print object. The system receives images from a nozzle camera. The nozzle camera captures images of the 3D printer nozzle dispensing the material. The system detects printing failures from the images of the 3D printer nozzle. The system creates bounding boxes around the printing failures. The system classifies the printing failures based on type of errors. In one example, the printing failures are classified into several classes, including, but not limited to, spaghetti, stringing, under extrusion and over extrusion. The system adjusts printing parameters or terminates the printing process based on the printing failures classified.

In one aspect of the present invention, the system includes a bracket for positioning the nozzle camera for capturing images of the 3D printer nozzle. The bracket mounts the nozzle camera such that the distance between the nozzle camera and the 3D printer nozzle is optimum for image collection and the high temperature of the 3D printer nozzle does not burn the nozzle camera. The bracket is configured for use with any of printers.

In another aspect of the present invention, the system changes the flow rate or retraction distance of the 3D printer to correct the 3D printing process when the printing failure is stringing failure or under/over extrusion. The system terminates the printing process when the printing failure is spaghetti. Further, the system generates a notification upon detecting the printing failures from the images of the 3D printer nozzle.

In one advantageous feature of the present invention, the nozzle camera targets directly at the nozzle. The system processes the images at a faster detection time with higher prediction accuracy. This ensures the errors are detected immediately using artificial intelligence (AI) model i.e., object detection model and the printing parameters setting is altered to fix the printing process very quickly.

In another advantageous feature of the present invention, the system adopts the most advanced object detection algorithm in deep learning, i.e., You Only Look Once (YOLO) algorithm. The object detection algorithm requires minimum hardware infrastructure while having outstanding detection accuracy and speed.

In another advantageous feature of the present invention, the system provides a specially designed bracket holding the nozzle camera. The nozzle camera points directly at the nozzle, where filament material is extruded. As such, the failures can be immediately recognized with the help of the AI model. Since the nozzle camera is close to the nozzle, the nozzle camera has a clear view of the failure and provides more information to the system to predict printing failures with more accuracy. Further, the design of the bracket is optimized to make sure that the bracket holds the nozzle camera for a long period without damage. Further, the bracket ensures the distance between the nozzle camera and the 3D printer nozzle is optimum for image collection and the high temperature of the 3D printer nozzle does not burn the nozzle camera. As a result, the nozzle camera is in a well-determined position for all types of 3D printing processes.

Features and advantages of the subject matter hereof will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

The present subject matter will now be described in detail with reference to the drawings, which are provided as illustrative examples of the subject matter to enable those skilled in the art to practice the subject matter. It will be noted that throughout the appended drawings, like features are identified by like reference numerals. Notably, the FIGUREs and examples are not meant to limit the scope of the present subject matter to a single embodiment, but other embodiments are possible by way of interchange of some or all of the described or illustrated elements and, further, wherein:

FIG. 1 illustrates an environment in which a system for enhancing reliability of fused deposition modelling (FDM) process implements, in accordance with one embodiment of the present invention;

FIG. 2 illustrates a block diagram of the system, in accordance with one embodiment of the present invention;

FIG. 3 shows a block diagram of a three-dimensional (3D) printer;

FIG. 4 illustrates a bracket for holding a nozzle camera, in accordance with one embodiment of the present invention;

FIGS. 5 through 8 illustrate spaghetti, stringing, and under extrusion and over extrusion printing failures, respectively, in accordance with one exemplary embodiment of the present invention; and

FIG. 9 illustrates a method of enhancing reliability of fused deposition modelling (FDM) process, in accordance with one embodiment of the present invention.

### DETAILED DESCRIPTION OF THE EMBODIMENTS

The detailed description set forth below in connection with the appended drawings is intended as a description of exemplary embodiments in which the presently disclosed subject matter can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed method and system. However, it will be apparent to those skilled in the art that the presently disclosed subject matter may be practiced without these specific details. In some instances, well-known structures and devices are shown in functional or conceptual diagram form in order to avoid obscuring the concepts of the presently disclosed method and system.

In the present specification, an embodiment showing a singular component should not be considered limiting. Rather, the subject matter preferably encompasses other embodiments including a plurality of the same component, and vice-versa, unless explicitly stated otherwise herein. Moreover, the applicant does not intend for any term in the specification or claims to be ascribed an uncommon or special meaning unless explicitly set forth as such. Further, the present subject matter encompasses present and future known equivalents to the known components referred to herein by way of illustration.

Although the present disclosure provides a description of a system for enhancing reliability of fused deposition modelling (FDM) process. The system instructs a three-dimensional (3D) printer to employ a 3D printer nozzle for dispensing material for forming a 3D print object. The system receives images from a nozzle camera. The nozzle camera captures images of the 3D printer nozzle dispensing the material. The system detects printing failures from the images of the 3D printer nozzle. The system creates bounding boxes around the printing failures. The system classifies the printing failures based on type of errors. The system adjusts printing parameters or terminates the printing process based on the printing failures classified. The system further includes a bracket for positioning the nozzle camera for capturing images of the 3D printer nozzle.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure.

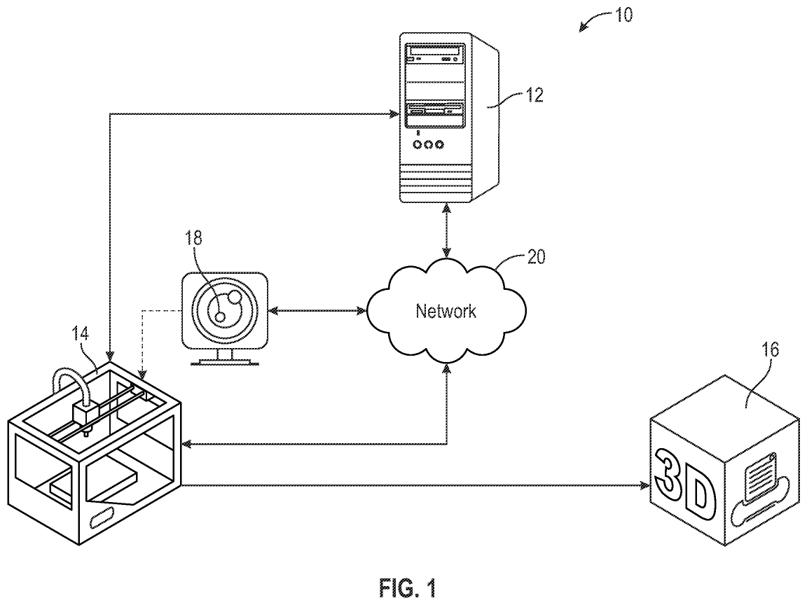

In one embodiment, the present invention discloses a system for enhancing reliability of fused deposition modelling (FDM) process. FIG. 1 shows an environment 10 in which system 12 implements for enhancing reliability of fused deposition modelling (FDM) process, in accordance with one exemplary embodiment of the present invention. System 12 includes a server or a database comprising an application to execute functions for enhancing reliability of fused deposition modelling (FDM) process by three-dimensional (3D) printer 14. In one embodiment, system 12 includes an Internet of Things (IoT) device, including but not limited to, Raspberry Pi™ and NVIDIA Jetson™ Alternatively, system 12 operates as a cloud server that controls 3D printer 14, and nozzle camera 18. In another embodiment, system 12 operates as a standalone device or connects to other (e.g., networked) systems. A person skilled in the art appreciates that system 12 implements in any different computing systems, environments, and/or configurations such as a workstation, an electronic device, a mainframe computer, a laptop, and so on. In a networked deployment, system 12 operates in the capacity of a server or a client machine in a server-client network environment, or as a peer machine in a peer-to-peer (or distributed) network environment. System 12 starts the printing job at 3D printer 14. System 12 controls printer 14, and captures the images from nozzle camera 18. System 12 enhances reliability of fused deposition modelling (FDM) process by 3D printer 14.

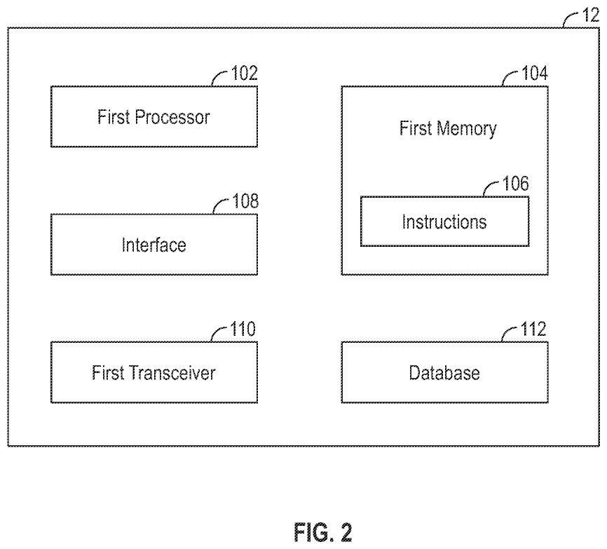

FIG. 2 shows a block diagram of system 12. System 12 includes first processor 102 and first memory 104. First processor 102 includes a central processing unit (CPU), graphics processing unit (GPU) or both. First processor 102 includes any suitable processing device, such as a microprocessor, microcontroller, integrated circuit, logic device, or other suitable processing devices.

First memory 104 communicates with first processor 102 via bus (not shown). First memory 104 includes one or more computer-readable media, including, but not limited to, non-transitory computer-readable media, RAM, ROM, hard drives, flash drives, or other memory devices. First memory 104 stores information accessible by the first processor 102, including computer-readable instructions 106 that can be executed by the first processor 102. In one example, the first memory 104 stores data that can be retrieved, manipulated, created, or stored by the first processor 102.

Instructions 106 may include any set of instructions that when executed by first processor 102, cause first processor 102 to perform operations. Instructions 106 may also reside, completely or at least partially, within first memory 104 and/or within first processor 104 during execution thereof by system 12, first memory 104 and first processor 104 also constituting machine-readable medium. Instructions 106 may further be transmitted or received over a network (not shown) via first transceiver 110 utilizing any one of a number of well-known transfer protocols or a custom protocol.

System 12 may include a user interface (UI) or simply an interface 108 i.e., software or Application interface allowing a user of a user device (not shown) to interact with system 12. In one exemplary implementation, user interface 108 may include a web application configured to allow the user to interact with system 12 to manage and operate 3D printers 14.

System 12 may include first transceiver 110 configured to send and receive data from system 12 to other devices such as 3D printer 14, nozzle camera 18, and other devices.

System 12 includes a database (cloud storage) 112. As such, system 12 acts as a cloud server. Database 112 indicates a data structure configured for storing information. In the current embodiment, database 112 includes 3D printer's data, 3D printing data, data corresponding to nozzle camera 18, user data, 3D modeling data, and other data.

In the present invention, 3D printer 14 includes any type of 3D printer and operates with various printing materials (e.g., plastics, powdered metals, ceramics, waxes, and so forth). In one embodiment, 3D printer 14 utilizes the additive manufacturing (AM) process as a primary means and/or technique. Here, 3D printer 14 produces, builds, prints and/or fabricates one or more components based on at least one 3D printable model for at least one 3D printable file format comprising the component. In another embodiment, the AM process includes one of an extrusion AM process, a laminated AM process, a wire AM process, a laser powder forming AM process, semiconductor epitaxial-thin film deposition process, circuit printing process, an inkjet 3D printing process, a light-polymerized AM process, a powder bed AM process, fused filament fabrication (FFF”) AM process and/or any combination(s) thereof.

In one example, the extrusion AM process includes fused deposition modeling (FDM), FFF, plastic jet printing and/or robocasting or direct ink writing. The laminated AM process includes laminated object manufacturing. The wire AM process includes an electron beam free form fabrication and/or laser metal deposition-wire AM process. The laser powder forming includes laser engineered net shaping (hereinafter “LENS”), direct metal deposition and laser consolidation. The light polymerized AM process includes a stereo lithography (SLA) and/or digital light processing. The powder bed AM process includes powder bed and inkjet head 3D printing, electron-beam melting (EBM), selective laser melting, selective heat sintering, selective laser sintering and/or direct metal laser sintering (DMLS).

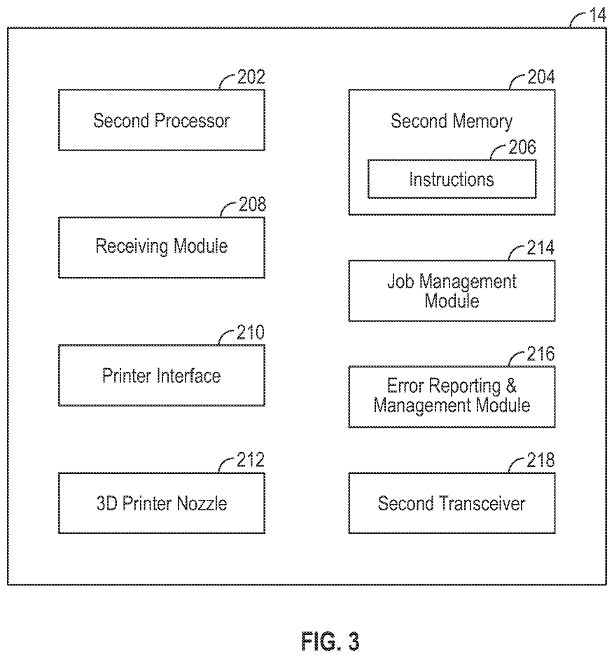

FIG. 3 shows a block diagram of 3D printer 14, in accordance with one embodiment of the present invention. 3D printer 14 includes second processor 202 and second memory 204. Second processor 202 includes a central processing unit (CPU), graphics processing unit (GPU) or both. Second processor 202 includes any suitable processing device, such as a microprocessor, microcontroller, integrated circuit, logic device, or other suitable processing devices. Second memory 204 includes one or more computer-readable media, including, but not limited to, non-transitory computer-readable media, RAM, ROM, hard drives, flash drives, or other memory devices. Second memory 204 stores information accessible by second processor 202, including computer-readable instructions 206 that can be executed by second processor 202.

3D printer 14 includes receiving module 208. Receiving module 208 configures to receive instructions from system 12 or via printer interface 210 for printing an object or 3D print job or 3D print object 16. Receiving module 208 receives the instructions in 3D computer models in one or more printable file formats including, but not limited to, G-code file format, 3MF file format, AMF file format, ZPR file format, FORM file format STL file format, WRL file format, and VRML file format. 3D computer model and/or CAD file. Receiving module 208 sends the instructions to second processor 202 such that second processor 202 converts the file into a 3D printable format and executes the print job.

3D printer 14 includes printer interface 210. Printer interface 210 includes a software or hardware interface allowing a user to interact with 3D printer 14. In one example, 3D printer 14 includes 3D printer nozzle 212. 3D printer nozzle 212 dispenses material for forming the three-dimensional construct i.e., 3D print object 16.

3D printer 14 includes job managing module 214 configured to monitor the status and performance of the print job. 3D printer 14 includes error reporting & management module 216 that triggers an alarm or sends a message to the user and stops 3D printer 14 from functioning.

3D printer 14 includes a second transceiver 218 configured to send and receive data from 3D printer 14 to other devices such as system 12, and other devices.

3D print object 16 includes a product that is produced, built, printed and/or fabricated by one or more components based on at least one 3D printable model by 3D printer 14.

System 12 includes nozzle camera 18. Nozzle camera 18 includes a camera, webcam, or other imaging capturing devices capable of capturing still images or video of 3D printer nozzle 212. In one example, nozzle camera 18 includes a wide-angle camera. In the present invention, nozzle camera 18 positions closer to 3D printer nozzle 212 and is configured to capture images of 3D printer nozzle 212.

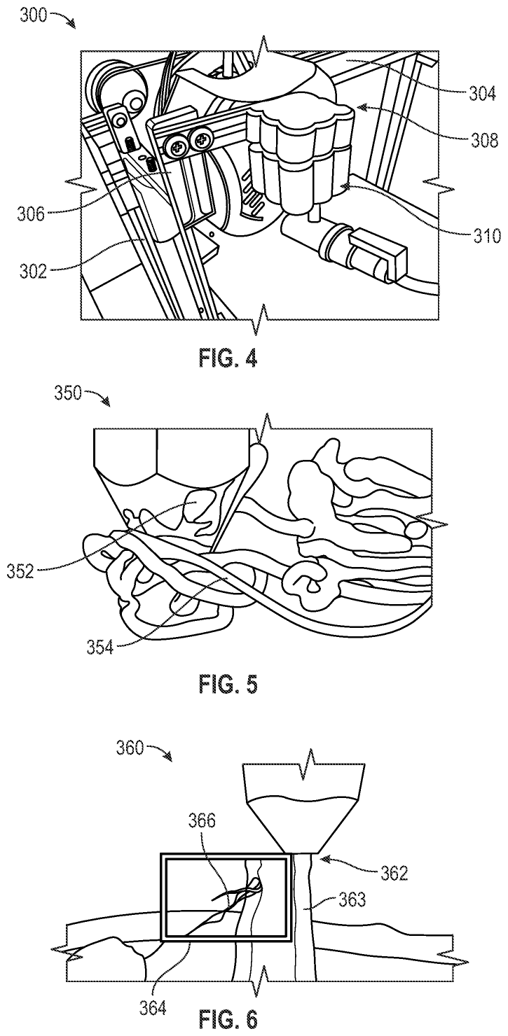

FIG. 4 shows a bracket 300, in accordance with one exemplary embodiment of the present invention. Bracket 300 includes frame 302 extending from a surface such as a table, for example. Frame 302 includes an extending member 304. Extending member 304 extends substantially perpendicularly to frame 302. Extending member 304 hingedly connects to frame 302 with the help of hinge bracket 306. Hinge bracket 306 helps in positioning extending member 304 such that nozzle camera 18 positions directly to 3D printer nozzle 212 for capturing images of 3D printer nozzle 212. In order to position nozzle camera 18, bracket 300 presents upper part 308 and lower part 310. In one implementation, upper part 308 comes in a variety of designs and accommodates the structure, size and shape of 3D printer 14. Lower part 310 comes in the same or different design for different 3D printers 14. Lower part 310 connects to upper part 308 using a variety of connection mechanisms. For example, lower part 310 connects to upper part 308 using a magnetic connection. Lower part 310 holds nozzle camera 18 to record the condition nozzle camera 18 at the time of dispensing material for forming 3D print object 16. As known, nozzle camera 18 generates high temperature and heat. The design of bracket 300 is optimized to make sure that bracket 300 holds nozzle camera 18 for a long period without damage. Further, bracket 30 ensures the distance between nozzle camera 18 and 3D printer nozzle 212 is optimum for image collection and the high temperature of 3D printer nozzle 212 does not burn nozzle camera 18. As a result, nozzle camera 18 is in a well-determined position for all types of 3D printing processes.

In one example, nozzle camera 18 monitors 3D printer nozzle 212 during the FDM printing process. Nozzle camera 18 includes a light-weighted, USB-connected camera e.g., USB endoscope camera that attaches to the moving 3D printer nozzle 212 with predesigned bracket 300.

In accordance with the present invention, nozzle camera 18 is capable of detecting printing failures including, but not limited to, “spaghetti”, “stringing”, under extrusion and over extrusion. “Spaghetti” is a specific failure type that is due to the faulty bed adhesion at the printing bed of 3D printer 14, which is hugely determined by the printer hardware precision and accuracy. FIG. 5 shows a feature of 3D printer 350 including 3D printing nozzle 352, in accordance with one exemplary embodiment of the present invention. As can be seen, FIG. 5 shows faulty bed adhesion 354 i.e., spaghetti failure.

Stringing is also referred to as oozing, whiskers or hairy prints. Stringing occurs when small strings of the material e.g., plastic are left behind on 3D print object 16. Stringing occurs due to plastic oozing out of 3D printing nozzle 212 which the extruder is moving to a new location. FIG. 6 shows an exemplary 3D printer 360 having 3D printing nozzle 362 causing a stringing failure. Here, 3D printing nozzle 362 dispenses material 363 for forming 3D print objects. FIG. 6 shows a bounding box 364 showing material 366 oozing out of 3D printing nozzle 362 which the extruder is moving to a new location.

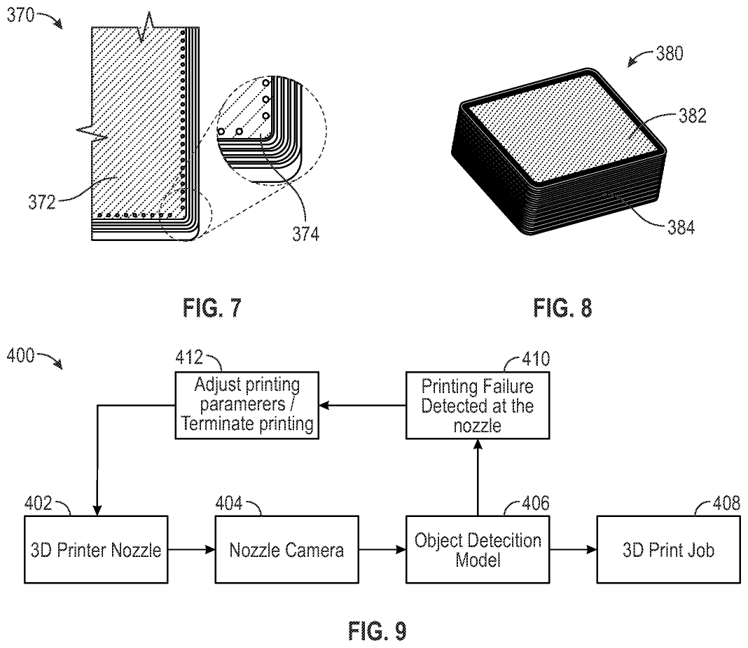

Under extrusion indicates a printing failure that occurs when too little material is extruded during a print. FIG. 7 shows an exemplary 3D print object 370 printed with multiple layers 372 having under extrusion 374 failure.

Over extrusion indicates a printing failure that occurs when too much material is extruded during a print. Over extrusion results in dimensional inaccuracy, layer drooping, stringing, oozing, blobs, and even jams during the 3D printing process. FIG. 8 shows an exemplary 3D print object 380 printed with multiple layers 382 having over extrusion 384 at the side of multiple layers 382.

In accordance with the present invention, nozzle camera 16 points directly at 3D printer nozzle 212, where filament material is extruded such that nozzle camera 16 can immediately recognize any anomaly and make real-time detections. Further, nozzle camera 16 mounts closer to 3D printer nozzle 212 and gets a clear view of the failure and provides more information to system 12. In one example, nozzle camera 16 has a light (not shown) targeting 3D printer nozzle 212. The light operates independent of the environment. In one example, the light ensures nozzle camera 16 captures images of 3D printer nozzle 212 in a dark setting such as at night or in a dark room. With specially designed bracket 300, nozzle camera 16 gets a better viewpoint of 3D printer nozzle 212 to detect failures at the 3D printer nozzle 212. In other words, nozzle camera 16 has enough angle of view to monitor the activities of 3D printer nozzle 212 and capture the failure features from 3D printer nozzle 212.

Referring to FIG. 9, method or workflow 400 of enhancing reliability of fused deposition modelling (FDM) process using a nozzle camera is explained, in accordance with one embodiment of the present invention. Method 400 helps to detect and correct FDM processes through detecting various types of printing errors at 3D printer nozzle 212 of the FDM 3D printer 14. The order in which method 400 is described should not be construed as a limitation, and any number of the described method blocks can be combined in any order to implement method 400 or alternate methods. Additionally, individual blocks may be deleted from method 400 without departing from the spirit and scope of the subject matter described herein. Furthermore, method 400 can be implemented in any suitable hardware, software, firmware, or combination thereof. However, for ease of explanation, in the embodiments described below, method 400 may be implemented using the above-described system 12.

At step 402, system 12 instructs 3D printer 14 to initialize. 3D printer 14 employs 3D printer nozzle 212 to dispense material to form 3D print object 16. Concurrently, system 12 employs nozzle camera 18 (step 404) to capture images of 3D printer nozzle 212. System 12 employs nozzle camera 18 to capture images and identifies printing failure types such as spaghetti, stringing, and under/over extrusion. System 12 uses nozzle camera 18 from both normal and defect printing status. Nozzle camera 18 continuously feeds images captured of 3D printer nozzle 212 condition to system 12 during the 3D printing process.

After capturing images, method 400 moves to step 406. At step 406, system preprocesses the images to construct a pertinent and annotated training dataset that is used as an input to an objection detection algorithm such as You Only Look Once (YOLO) object detection algorithm, for example. In one example, system 12 processes the images at the speed of approximately but is not limited to 3˜30 frames per second (FPS). System 12 applies data augmentation techniques such as translation, rotation, and shear to boost image diversity and improves the performance of the objection detection model. Further, the images of the dataset are resized to ensure the same dimension of image input for model training. Subsequently, the image data is normalized to ensure the best performance of the model training.

System 12 processes object detection model to achieve a balance between the number of layer outputs and convolutional layers, the resolution of the input network, and the number of parameters. By feeding the images (i.e., image snapshots) taken by nozzle camera 18, system 12 utilizing the object detection model such as CSPDarknet53 generates a partitioned feature map. To enhance the feature extraction, system 12 adopts a Spatial pyramid pooling (SPP) and Path Aggregation Network (PAN) to increase the neck receptive field, thus improving the object detection model's performance. Further, system 12 creates a multi-layered feature map called anchor boxes for the stage of identification by the objection detection model. Furthermore, system 12 outputs the state of 3D printer nozzle 212 and indicates possible printing errors for users, with bounding boxes located and the predicted failure type.

In the present embodiment, system 12 detects failure types including, but are not limited to, spaghetti, stringing, under-extrusion, over-extrusion, etc. As specified above, the spaghetti failure is often caused by poor bed adhesion. Since 3D print objects 16 in the FDM process are printed by building up materials layer by layer, 3D print objects 16 end up with plastic spaghetti instead of a clean printed part if layers come off the previous printed layer/print bed. The stringing error occurs when small strings of plastic are left behind on a 3D printed object 16, which is due to plastic material oozing out of 3D printer nozzle 212 while the extruder is moving to a new location. Under-extrusion occurs when there is less plastic exiting 3D printer nozzle 212 than what system 12 expects, so that gaps can be noticed between adjacent extrusions. Over-extrusion occurs when 3D printer nozzle 212 extrudes more plastic than system 12 expects, which results in excess plastic that can ruin the outer dimensions of 3D print object 16.

From the images received from nozzle camera 18, if system 12 detects that there are no errors, then method 400 moves to step 408 where 3D print object 16 is printed. If system 12 detects a failure, then system 12 creates bounding boxes that precisely label the error area on the captured images (step 410). Further, system 12 classifies the type of printing error based on the error detected. In one example, upon identifying the error i.e., 3D printing failure, system 12 sends a notification to users about the detected failure. If the failure is “spaghetti”, then system 12 terminates 3D printing immediately and waits for human intervention (step 412). If the failure is “stringing” or “under/over extrusion”, system 12 automatically adjusts/changes the flow rate or retraction distance of the printing to correct the printing process (step 412).

The presently disclosed system 12 equipped with a specially designed bracket 300 and nozzle camera 18, and the advanced object detection model reduces the time and material wasted for failed prints, and also improves the success rate of FDM printers. In one implementation, system 12 improves the efficiency and accuracy of the object detection model by tuning multiple hyper parameters (step 412) using techniques like k-fold cross validation. In one example, system 12 simulates concurrent usages of images with a large number of 3D printers 14. Once the objection detection model is optimized, system 12 integrates the objection detection model in the existing 3D printers to improve the success rate of FDM printers.

Based on the above, it is evident that during 3D printing operations, the presently disclosed system utilizes deep learning techniques to detect and correct FDM processes through detecting various types of printing errors at the 3D printing nozzle of the 3D printer. System utilizes the nozzle camera to capture images of the 3D printing nozzle to overcome the current limitations. The nozzle camera points directly at the 3D printing nozzle, where filament material is extruded. The system receives the images and immediately recognizes any anomaly and makes real-time detections. Since the nozzle camera is close to the 3D printing nozzle, the nozzle camera provides a clear view of the failure and provides more information for the system to predict failures more accurately. The system thus has an improved prediction accuracy compared to current systems that use conventional recording cameras. Further, the system adopts the most advanced object detection algorithm or model in deep learning, i.e., You Only Look Once (YOLO). The object detection algorithm model requires minimum hardware infrastructure and provides outstanding detection accuracy and speed. This reduces the time and material wasted for failed prints, and improves the success rate of FDM printers.

The present invention has been described in particular detail with respect to various possible embodiments, and those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. In addition, the particular division of functionality between the various system components described herein is merely exemplary, and not mandatory; functions performed by a single system component may instead be performed by multiple components, and functions performed by multiple components may instead be performed by a single component.

Some portions of the above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, should be understood as being implemented by computer programs.

Further, certain aspects of the present invention include process steps and instructions described herein in the form of an algorithm. It should be noted that the process steps and instructions of the present invention could be embodied in software, firmware, or hardware, and when embodied in software, could be downloaded to reside on and be operated from different platforms used by real-time network operating systems.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for disclosure of enablement and best mode of the present invention.

It should be understood that components shown in FIGUREs are provided for illustrative purposes only and should not be construed in a limited sense. A person skilled in the art will appreciate alternate components that may be used to implement the embodiments of the present invention and such implementations will be within the scope of the present invention.

While preferred embodiments have been described above and illustrated in the accompanying drawings, it will be evident to those skilled in the art that modifications may be made without departing from this invention. Such modifications are considered as possible variants included in the scope of the invention.

What is claimed is:

1. A method of enhancing reliability of fused deposition modelling (FDM) process, the method comprising steps of:
instructing, by a processor, a three-dimensional (3D) printer to employ a 3D printer nozzle for dispensing material for forming a 3D print object;
receiving, by the processor, images from a nozzle camera, the nozzle camera capturing images of the 3D printer nozzle dispensing the material;
detecting, by the processor, printing failures from the images of the 3D printer nozzle;
classifying, by the processor, the printing failures; and
adjusting, by the processor, printing parameters or terminating the printing process based on the printing failures classified.

2. The method of claim 1, wherein the printing failures are classified into one of spaghetti, stringing, under extrusion and over extrusion.

3. The method of claim 1, further comprising creating, by the processor, bounding boxes around the printing failures.

4. The method of claim 2, wherein the step of adjusting printing parameters comprises:
changing the flow rate or retraction distance of the 3D printer to correct the 3D printing process when the printing failure is classified as stringing failure.

5. The method of claim 2, wherein the step of adjusting printing parameters comprises:
changing the flow rate or retraction distance of the 3D printer to correct the 3D printing process when the printing failure is classified as under extrusion.

6. The method of claim 2, wherein the step of adjusting printing parameters comprises:
changing the flow rate or retraction distance of the 3D printer to correct the 3D printing process when the printing failure is classified as over extrusion.

7. The method of claim 2, wherein the step of terminating the printing process comprises:
terminating the printing process when the printing failure is classified as spaghetti.

8. The method of claim 7, further comprising generating a notification upon detecting the printing failures from the images of the 3D printer nozzle.

9. The method of claim 1, further comprising providing a bracket for positioning the nozzle camera for capturing images of the 3D printer nozzle.

10. A system for enhancing reliability of fused deposition modelling (FDM) process, the system comprising:
a processor; and
a memory coupled to the processor, wherein the processor is configured to execute program instructions stored in the memory, to:
instruct a three-dimensional (3D) printer to employ a 3D printer nozzle for dispensing material for forming a 3D print object;
receive images from a nozzle camera, wherein the nozzle camera captures images of the 3D printer nozzle dispensing the material;
detect printing failures from the images of the 3D printer nozzle;
create bounding boxes around the printing failures;
classify the printing failures; and
adjust printing parameters or terminate the printing process based on the printing failures classified.

11. The system of claim 10, further comprises a bracket, wherein the bracket mounts the nozzle camera.

12. The system of claim 11, wherein the bracket positions the nozzle camera for capturing images of the 3D printer nozzle.

13. The system of claim 12, wherein the bracket mounts the nozzle camera such that the distance between the nozzle camera and the 3D printer nozzle is optimum for image collection and the high temperature of the 3D printer nozzle does not burn the nozzle camera.

14. The system of claim 10, wherein the printing failures are classified into one of spaghetti, stringing, under extrusion and over extrusion.

15. The system of claim 14, wherein the processor executes the program instructions to change the flow rate or retraction distance of the 3D printer to correct the 3D printing process when the printing failure is classified as stringing failure.

16. The system of claim 14, wherein the processor executes the program instructions to change the flow rate or retraction distance of the 3D printer to correct the 3D printing process when the printing failure is classified as under extrusion.

17. The system of claim 14, wherein the processor executes the program instructions to change the flow rate or retraction distance of the 3D printer to correct the 3D printing process when the printing failure is classified as over extrusion.

18. The system of claim 14, wherein the processor executes the program instructions to terminate the printing process when the printing failure is classified as spaghetti.

19. The system of claim 14, wherein the processor executes the program instructions to generate a notification upon detecting the printing failures from the images of the 3D printer nozzle.

20. A non-transitory machine-readable storage medium having instructions stored thereon which, when executed by a processor of a system enhancing reliability of fused deposition modelling (FDM) process, causes the system to perform operations comprising:
instructing a three-dimensional (3D) printer to employ a 3D printer nozzle for dispensing material for forming a 3D print object;
receiving images from a nozzle camera, the nozzle camera capturing images of the 3D printer nozzle dispensing the material;
detecting printing failures from the images of the 3D printer nozzle;
creating bounding boxes around the printing failures;
classifying the printing failures; and
adjusting printing parameters or terminating the printing process based on the printing failures classified.
